(19) United States
(12) Patent Application Publication
(10) Pub. No.: US 2012/0065777 A1
(43) Pub. Date: Mar. 15, 2012

(54) Method for operating a gripping device

(76) Inventor: Christian Marx, Reutlingen (DE)

(21) Appl. No.: 13/199,993

(22) Filed: Sep. 14, 2011

(30) Foreign Application Priority Data
Sep. 15, 2010 (DE) 10 2010 037 548.9

(51) Int. Cl. B25J 9/16

(52) U.S. Cl. 700/245; 901/31

(57) ABSTRACT

A method for operating a gripping device (10) is provided. This method is used for positioning blanks (18) in a working position for the placement of said blanks in a clamping chuck (35). For this, a deviation function (F) is determined at the time of initialization of the gripping device (10), said deviation function stating only—for the working position—the load-dependent deviation of the position of the blank (18) from its desired nominal position relative to the position measured in the gripping device. During operation, while the gripping device (10) is positioning the blank (18) in the working position, it is possible to determine a deviation value (Δza) with the use of the deviation function (F) and to correct the position measured in the gripping device (10) with the deviation value (Δza), so that an accurate positioning of the blank (18) is possible.

### CROSS-REFERENCE TO RELATED APPLICATION

This application claims the priority of German Application No. 10 2010 037 548.9 filed Sep. 15, 2010.

### BACKGROUND OF THE INVENTION

The invention relates to a method for operating a gripping device. The gripping device comprises a gripping arm or manipulator that has several members that can be rotatably or pivotally connected with each other. Between each two adjacent members, there is arranged an adjustment drive having a rotational axis or pivoting axis so as to rotate or pivot the two members connected via the adjustment drive relative to each other. The number of adjustment drives may vary. For example, five or six adjustment drives may be provided.

The gripping device can be used for different tasks. For example, it can be disposed to remove blanks from a pallet and set them into a chuck device of a machining tool and, conversely, remove machined workpieces from the chuck device and deposit them on the pallet. For this purpose, the gripping device comprises a gripper with at least one and, for example, two gripping tongs. In some applications, blanks of different sizes are machined in the machining tool. Therefore, the weight to be borne by the gripping arm varies. This affects the positioning accuracy of the gripper. It has been found that already with load differences of a few kilograms, positional deviations of up to approximately two millimeters can occur when the blank is set in the chuck device. In doing so, when blanks are repeatedly set in a chuck device, it may happen that the chuck device is damaged or that at least the wear on the chuck device is increased. Considering a clamping chuck acting as the chuck device, concentricity can be impaired and involve costly repairs. The present invention is to prevent this.

From publication DE 10 2007 026 114 A1 it has been known to deduce the borne load based on the current drawn by a motor of a robotic arm. Due to the proportionality of the motor current relative to the torque and the known geometric configuration of the robotic arm, it is possible to calculate the load. In a computing unit, the compensation of the elastic deformation due to the load can then be taken into account at the time of positioning. A computer can then be used to consider the compensation of the elastic deformation due to the load at the time of positioning. There is no exact information as to how this compensation is to function.

In order to compensate for errors of a position adjustment in a machine with at least one axis, publication DE 103 12 025 A1 has suggested that the deformation of the machine be calculated as a function of the values causing the deformation in each spatial direction. This can be accomplished, for example with the use of a finite element method (FEM) or with a boundary element method (BEM). In doing so, it is possible not only to determine and quantify longitudinal elongations but also bending or torsions or other complex deformation conditions of the machine. However, this method necessitates a considerable amount of programming. In addition, the operation of the machine requires a considerable computing effort for the continuous calculation of the actual deformation.

Considering this, it can be viewed as being the object of the present invention to provide a method that enables the highly simple and exact positioning of a workpiece or a blank, depending on the load on the gripping arm.

### SUMMARY OF THE INVENTION

This object is achieved with a method displaying the features of claim 1 and the following claims dependent thereon and claim 13. Independently thereof, the invention also relates to a gripping device that is adapted to perform the method.

In accordance with the invention, the method as in claim 1 is used to determine a deviation function. The deviation function describes the change of the position of the gripper arranged on the free end of the gripping arm, dependant on the load on said gripping arm. In particular, in doing so, the position change relates to the vertical Z-direction, in which the weight of the load acts on the gripper. In accordance with the invention, the deviating function is performed by at least two position measurements with different gripper loads. Considering the two position measurements, the gripper is in the same pre-specified measuring position that, preferably, essentially corresponds to the position in which the workpiece or the blank is to be positioned in a working position. In the measuring position, the members of the gripping arm are in a pre-specified position relative to each other.

For example, in each loading situation a position value is measured in Z-direction in the coordinate system of the gripping device. Due to the different loads, the measured position values are different from each other. These two measured position values can then be used in a deviation function, in particular as a linear deviation function. Subsequently, this deviation function can be used when loading and unloading blanks in the working position in order to correct—independently of the actual loading operation—the position value in the coordinate system of the gripping device and to achieve, in this manner, an exact positioning of the workpiece or blank.

Indeed, the thusly determined deviation function applies only to a small spatial region around the working position. The reason being that the deviation function determined in this manner is only sufficiently accurate when the members of the gripping arm essentially assume the relative position pre-specified in the measuring position and in the working position. If the members of the adjustment drives are brought into another relative position, the stiffness of the gripping arm changes so that the deviation function no longer displays sufficient accuracy. Considering an advantageous embodiment, it is also possible to determine a respectively allocated deviation function for several working positions within the working region of the gripping device. During operation of the gripping device it is frequently sufficient to achieve a high positioning accuracy within the range of a few hundredths or at least a few tenths of millimeters in one or optionally several working positions. While the blank or the workpiece is being transported between such working positions, it is only necessary to ensure that there will be no collision with other machine elements, in which case, however, an accuracy in the range of a few millimeters is sufficient. Therefore, the present invention offers an extremely simple possibility of achieving the exact positioning of the workpieces or blanks in one or several working positions with a very minimal programming effort.

The determined deviation function also takes into account any structural tolerances of the gripping device. Also, joints, bearings and other structural elements are not identical even in gripping elements of the same type and can thus not be sufficiently represented by a single mathematical model. By determining the deviation function in accordance with the invention at the time when the gripping device is being initialized, such structural tolerances are automatically taken into consideration. It is very easy to teach the gripping device on site. After teaching, an appropriate deviation function is available for each pre-specified working position and the exact positioning of the blanks and workpieces in the existing working positions is thus ensured during operation of the gripping device.

Considering a preferred embodiment, the deviation function takes is determined as follows: In a first loading state, a torque value of an adjustment drive of the gripping arm is detected, said value describing the actual load on the gripper in a first loading state. Subsequently, the gripper or the gripping arm is moved into the pre-specified measuring position, in which case the members of the gripping arm assume a pre-specified position relative to each other. In the measuring position, a first position value of the gripper in the first loading state in the coordinate system is detected. Based on the known actual position assumed by the gripper in the measuring position and the measured first position value, it is possible to determine a first deviation value. Subsequently, the described steps are repeated for a second loading state, whereby a second deviation value results for the second loading state. Based on these two deviation values and the two torque values, it is possible to determine a preferably linear deviation function that describes the deviation value as a function of the torque value. Such a linear deviation function can be determined in a particularly simple manner with a minimal computational effort. The deviation function can be stored as an equation or in the form of a table in a control unit of the gripping device. During continued operation of the gripping device for positioning the gripper or the blanks or workpieces held by the gripper, the deviation will be used in the respective working position of the gripping arm.

Preferably, in the first loading state, the gripper is not loaded, i.e., the gripper does not bear any load whatsoever. In the second loading state, the gripper is loaded, in particular, with the maximum load that occurs during operation of the gripping device. In a preferred exemplary embodiment, the gripper comprises two gripping tongs. In doing so, the maximum load comprises two blanks or workpieces, each with the greatest mass that is to be transported.

In a preferred method, the gripper or gripping arm is moved against an abutment element so as to exactly define the measuring position of said gripper or gripping device. Preferably, the gripper is moved from the top in an approximately vertical direction against the abutment element. In particular, the abutment element is arranged at the point at which the gripper is in the working position of the gripping arm and for which the deviation function is to be determined. For example, the abutment element may be a body, for example a blank, that is mounted in a clamping chuck.

It is advantageous when the members of the gripping arm are located in a pre-specified torque detection position for the determination of the torque values. In the torque detection position, the position or location of the members of the gripping arm relative to each other can essentially correspond to the relative position of the members in the working position and/or measuring position in such a manner that the stiffness and elasticity of the gripping arm in the torque detection location and the working position and/or the measuring position can be compared with each other. In this manner, it is possible to achieve a further improvement of the accuracy when determining the deviation function.

In a preferred embodiment, the axis of the adjustment drive that is used for determining the torque values is essentially aligned in horizontal direction while the torque values are being determined. In doing so, the weight of the load on the gripper acts in downward direction at a right angle with respect to the axis. The concentration of the load is located outside the vertical plane that comprises the axis. This makes possible an exact determination of the torque value as a function of the weight of the load.

The method is further simplified when only a single adjustment drive of the gripping device is used for the determination of the torque values. Preferably, the torque values are determined via an adjustment drive that is located as closely as possible to the gripper. In particular, the adjustment drive that is selected is the one that is closest to the gripper and whose axis does not bisect the gripper. Preferably, there is at most one other adjustment drive between the adjustment drive that is used for the determination of the torque values and the gripper. In this embodiment of the method, the spread of the torque values in different loading states is sufficiently large to be able to determine an exact deviation function. Inasmuch as the transmission ratios of the individual adjustment drives multiply to a total transmission ratio that is greater than i=1, the spread of the torque value decreases due to load differences on the gripper the more adjustment drives comprising a gearing step are interposed between the adjustment drive that is used for measurement and the gripper. It has been found that this is disadvantageous for the determination of the torque values and thus for the accuracy of the deviation function, even if the size of the lever arm increases between the loading operation and the adjustment drive used for measuring when several members and adjustment drives are interposed.

In the method for operating the gripping device, the pre-specified or determined deviation function is used for picking up and/or depositing a workpiece or a blank. In particular, the following steps are performed:

First a blank or a workpiece is grasped with the gripper. Frequently, in doing so, a load-dependent deviation is not taken into account, for example when the blank or the workpiece is removed from a pallet and when there is sufficient space available.

Subsequently, a torque value characteristic of the gripper load is determined. To accomplish this, preferably the adjustment drive that is being used was also used for the determination of the deviation function.

Based on the pre-specified deviation function, a deviation value is determined as a function of the previously determined torque value.

This deviation value is added to the actual position value measured in the coordinate system of the gripping device in order to be able to precisely position the blank or workpiece in the working position. In the working position, the relative position of the members essentially corresponds to the relative position of the members of the gripping arm in measuring position.

### BRIEF DESCRIPTION OF THE DRAWINGS

Advantageous embodiments of the present invention can be inferred from the dependent claims as well as from the description. The description is restricted to essential features of the invention as well as to miscellaneous situations. For supplementary information, reference is to be made to the drawings; as shown in:

FIG. 1 is a perspective representation of a gripping arm with a pallet, as well as a schematically illustrated chuck device in a machine tool;

FIG. 2 is a block circuit diagram of the gripping device in the measuring position in the region of the chuck device of the machine tool;

FIG. 3 is a schematic plan view of the gripper with maximum load in the measuring position;

FIG. 4 is the gripper of FIG. 3 in a torque detection position;

FIG. 5 is a block circuit diagram of an adjustment drive; and

FIG. 6 is the schematic representation of an exemplary linear deviation function.

### DETAILED DESCRIPTION OF VARIOUS EMBODIMENTS

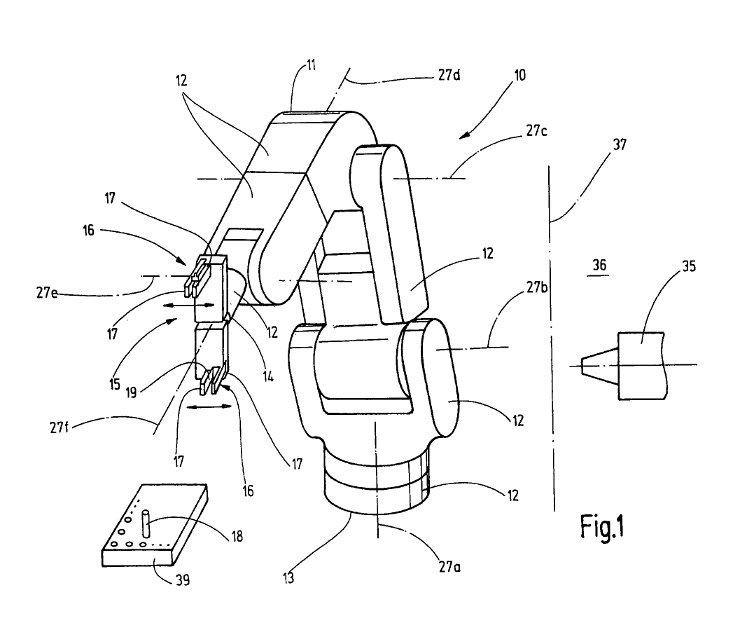

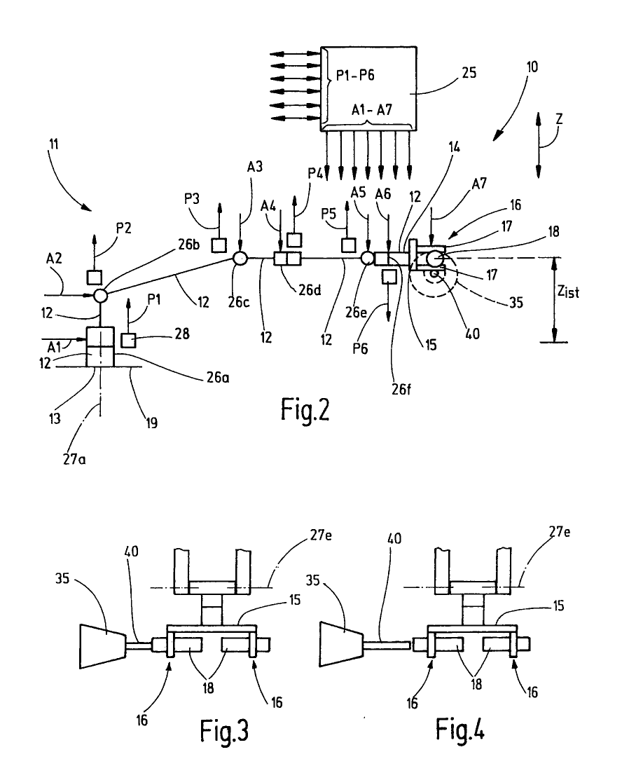

FIGS. 1 and 2 show an exemplary embodiment comprising a gripping device 10 with a gripping arm 11. The gripping arm 11 comprises several members 12 that are rotatably and pivotally connected with each other. At a mounting end 13, the gripping arm 11 is fixed in place on a mounting surface 19. On its free end 14 opposite the mounting end 13, the gripping arm 11 bears a gripper 15. The gripper 15 comprises at least one and, as in the example, two gripping tongs 16 that can be actuated independently of each other. Each set of gripping tongs 16 comprise two tong legs 17 which can be shifted relative to each other and between which a blank 18 or a machined workpiece can be clamped and held. In the exemplary embodiment, it is, in particular, cylindrical parts that are to be held by the gripping tongs 16. Therefore, one of the tong legs 17 may have a prism-shaped recess to ensure that the cylindrical blank 18 or workpiece is securely held and positioned.

The gripping device 10 comprises several adjustment drives 26 that can be activated by a control unit 25. Considering the exemplary embodiment described herein, six adjustment drives 26a through 26f are provided, whereby each adjustment drive connects two adjacent members 12 of the gripping arm 11 so as to be rotatable or pivotable about a respectively associate rotational axis or pivoting axis 27a through 27f. The activation of the adjustment drives 26a through 26f is accomplished by the activation signals A1 through A6 of the control unit 25. Due to another activation signal A7, the gripping tongs 16 are opened or closed. For positioning the gripper 15 or a blank 18 held in the gripper 15, the control unit 25 receives position signals P1 through P6 from the position sensors 28. In the exemplary embodiment, each adjustment drive 26a through 26f is allocated a position sensor 28.

The first adjustment drive 26a directly follows the end of the gripping arm 11, said end being fixed in place on the mounting surface 19. This drive is configured as a rotary drive, the rotational axis 27a of said drive extending essentially in vertical direction. By means of a member 12, the first adjustment drive 26a is connected with a second adjustment drive 26b, said second adjustment drive being connected, via another member 12, with a third adjustment drive 26c. The second and the third adjustment drives 26b and 26c are designed as pivot drives having pivoting axes 27b and 27c, respectively, that extend essentially parallel to each other and at a right angle relative to the rotational axis 27a of the adjustment drive 26a. The fourth adjustment drive 26d is designed as a rotary drive and is seated between two members 12 that connect the third adjustment drive 26c with a fifth adjustment drive 26e, the latter representing a pivot drive. The rotational axis 27d of the fourth adjustment drive 26d is aligned at a right angle with respect to the pivoting axes 27c and 27e of the third and fifth adjustment drives 26c and 26e, respectively. Finally, a sixth adjustment drive 26f is provided, said drive being arranged between the fifth adjustment drive 26e and the gripper and being configured as a rotary drive. The rotational axis 27f of the latter extends through the gripper 15 approximately in the middle between its two gripping tongs 16.

A not specifically illustrated input and/or output means can be connected with the control unit 25 so that any data and values can be input by an operator or output to an operator. Furthermore, the control unit 25 can comprise an internal memory or be connected with an external memory in order to read out or store data.

Furthermore, a chuck device, for example a clamping chuck 35, is provided in a not specifically illustrated machine tool so as to be immovable relative to the mounting end 13 of the gripping arm 11 in the three-dimensional working region of the gripping device 10. The clamping chuck 35 is located in a machining region 36 of the machine tool, said machining region being separated from the gripping arm 11 by means of a dividing wall 37. The dividing wall 37 comprises an opening that can be closed, in which case the gripping arm with the gripper 15 can extend and reach the clamping chuck 35 through said opening.

In the working region of the gripping device 10 outside the machining region 36, there is arranged a pallet 39 in which blanks 18 or machined workpieces can be deposited. It is understood that it is also possible to provide several pallets 39.

The gripping device 10 is disposed to remove a blank 18 from the pallet 39 and transport said blank to the clamping chuck 35. With the gripping tongs 16 still empty, the gripper 15 grasps the machined workpiece that is still located in the clamping chuck 35 and removes said workpiece. The gripper 15 is rotated and, with the other gripping tongs 16, inserts the blank removed from the pallet 39 in the clamping chuck 35. The machined workpiece is transported back to the pallet 39 and, in the meantime, the blank 18 in the clamping chuck 35 is machined by the no longer shown machine tool. The machined workpiece is deposited on the pallet 39, and the next blank 18 is removed. While the machine tool is in operating mode, this process is cyclically repeated.

The positioning accuracy of the gripper 15 when the blank 18 is being set into the clamping chuck 35 is subject to particular requirements. Wear or damage to the clamping chuck 35 are to be absolutely avoided. Considering the exemplary embodiment described herein, the gripping device 10 is in its working position when the blank 18 removed from the pallet is being inserted into the clamping chuck 35. In this working position, the positioning accuracy of the blank must be a given, regardless of the size of the weight of the load that is currently borne by the gripper 15. In some applications, the blanks 18 and the machined workpieces have different sizes and weights. Due to the elasticity of the gripping arm 11, there may be load-dependent deviations. Such deviations are restricted to a permissible tolerance range by the method described herein.

For the operation of the gripping device 10, a deviation function F is first determined. The deviation function F indicates the positional deviation of the blank 18 held in the gripper 15 in the working position of the gripping arm 11 as a function of the loading state of the gripper 15. Based on this deviation function F, it is possible to determine a deviation value Δz that, subsequently, can be used for the correction of the position of the blank 18, said position having been determined via the position signals P1 through P6.

In order to determine the deviation function F, the gripper 15 is first brought into a first loading state. Considering a preferred exemplary embodiment, the gripper 15, in doing so, is not loaded, i.e., there is no blank 18 or a workpiece held in any of the gripping tongs 16. In this first loading state, the gripping arm 11, as shown by the example, is moved into a torque detection location that approximately corresponds to the position that is taken by the gripping arm 11 in its working position. Considering the exemplary embodiment described herein, the gripping arm 11 is only rotated relative to its working position about the vertical rotational axis 27a of the first adjustment drive 26a. The rotational position about the rotational axis 27a, however, does not result in any or only in an unsubstantial change of elasticity or stiffness of the gripping arm 11, so that this is without effect on the determination of the deviation function F. In doing so, the gripper 15 is approximately in the vicinity of the clamping chuck 35 as shown by FIG. 4.

In the torque detection location, a first torque value M1 is detected by actuating the fifth adjustment drive 26e, said torque detection value being allocated to the first loading state. The torque of the motor of the fifth adjustment drive 26e or another value describing the torque such as, for example, the motor current, may be measured as the torque moment M. The first torque value M1 may also be determined several times in sequence, and a mean value may be determined by known mathematical procedures. In doing so, the torque necessary for pivoting of the gripper 15 about the pivoting axis 27e of the fifth adjustment drive 26e can be determined directly or indirectly as the first torque M1.

After determining the first torque value M1, the gripping arm 11 is moved into its measuring position, said position being schematically represented in FIGS. 2 and 3. Considering the exemplary embodiment described herein, the measuring position is pre-specified by an abutment element 40, against which the gripping tongs 16 are moved for inserting the blank 18 into the clamping chuck 35. For example, a body mounted in the clamping chuck 35 can act as the abutment 40. Considering the exemplary embodiment, the movement toward the measuring position is vertical from the top in the direction of the weight of the gripper 15 or the load of said gripper. Preferably, the gripper 15 is first positioned via the measuring position defined by the abutment element 40 and is subsequently moved downward in essentially vertical direction. As soon as the gripper 15 abuts against the abutment 40, a first position value z1 is measured in Z-direction, this corresponding to the vertical direction in this instance, in the coordinate system of the gripping device 10. The position measurement is based on the values of the position sensors 28 of the gripping device 10. It is also possible to repeatedly and successively perform the measurement of this position value in Z-direction and to form a mean value.

Subsequently, loading the gripper 15 is changed to the second loading state. In accordance with the example, the maximum load possible during operation of the gripping device 10 is applied to the gripper 15. In the exemplary embodiment described herein, this corresponds to arranging two blanks 18 with the greatest-possible weight in the two sets of gripping tongs 16 of the gripper 15, as is shown in FIG. 3. In the second loading state, a second torque value M2 is detected as previously described in conjunction with the first loading state. Subsequently, a second position value z2 is determined in Z-direction in the measuring position of the gripping arm 11 in a manner analogous to the procedure used for the first loading state. Based on the first position value z1 measured in the first loading state and the second position value Z2 measured in the second loading state, a deviation value Δz1 or Δz2 is calculated as follows:

Δz1=zist−z1

Δz2=zist−z2,

wherein zist is the actual position value of the gripper 15 or the blank 18 in Z-direction when the gripping arm 11 is in its measuring position, namely, when the gripper 15 is in contact with the abutment 40 in the exemplary embodiment.

In this manner, two defined points, namely M1/Δz1 and M2/Δz2, of the deviation function F are obtained. It has been found that a linear deviation function F provides sufficient accuracy for the region of the working position of the gripping arm 11. In addition, such a linear deviation function F can be very easily determined based on only two points. Consequently, these two points result in the deviation function F that is shown as an example in FIG. 6. The validity of this deviation function can be restricted to the region between the first torque value M1 and the second torque value M2 when the not loaded gripper 15 in the first loading state and the maximum permissible load in the second loading state are used. Alternatively, however, it is also possible to select any other different loading states and to use the deviation function F beyond the range between the two determined pairs of values, as is shown in a dotted line in FIG. 6.

In the working position, the members 12 of the gripping arm 11 are in essentially the same relative position as in the measuring position and, optionally, in the torque detection position. In doing so, the rotating or pivoting positions of the second through the sixth adjustment drives 26b through 26f are essentially identical. Only the rotating or pivoting positions about the vertical axes such as, for example, about the rotational axis 27a of the first adjustment drive 26a on the mounting end 13 of the gripping arm 11, do not have any or only a negligible effect on the deformation of the gripping arm under load on the gripper 15, so that these rotational positions may also be different in the working position, the measuring position and, optionally, the torque detection position.

After the deviation function F has been determined, said function is deposited in the form of an equation or a table in the memory of the control unit 25. When a blank 18 is being positioned at the working site, i.e., when a blank 18 is being inserted into the clamping chuck 35 in the present case, the already determined deviation function F is retrieved and the position value that has been measured by a sensor means in the gripping device 10 is corrected in Z-direction by a correction value Δz in order to achieve a sufficiently exact positioning of the blank 18. This is accomplished in the following manner:

After the gripper 15 has removed a blank 18 from the pallet 39, the gripping arm 11 is moved into its torque detection position. Subsequently, a torque value Ma characteristic of the actual load on the gripper 15 is detected. Also in this case—like in the determination of the deviation function F—only the fifth adjustment drive 26e is used.

After the torque value Ma has been detected, it is possible to use the pre-specified deviation function F for the determination of the associated deviation value Δza. When the blank is being moved into the working position, i.e., when the blank 18 is being set into the clamping chuck 35, the actual position value measured in Z-direction is corrected by the addition of the determined deviation value Δza in order to ensure sufficiently accurate positioning when the blank is being set into the clamping chuck 35.

While the torque values M1, M2, Ma are being determined, the axis 27e of the fifth adjustment drive 26e used therefore is essentially in horizontal alignment. This increases the accuracy of the interrelationship between the detected torque value M1, M2, Ma and the weight of the load of the gripper 15.

When the torque values M1, M2, Ma are determined, only a single adjustment drive 26e is being used. While the torque values M1, M2, Ma are being determined, all the other adjustment drives remain at rest. In the case described herein, the adjustment drive that is used is the one that is arranged as closely as possible to the gripper 15. Preferably, there is at most one other adjustment drive 26f between the adjustment drive 26e used for torque value determination and the gripper 15. In the present case, the sixth adjustment drive 26f, the rotational axis 27f of which extends in the middle between the two gripping tongs 16 through the gripper 15, was not used because—when the two gripping tongs 16 are uniformly loaded—there is a balancing weight, as it were, and a determination of the torque value corresponding to the loading state of the gripper 15 cannot be achieved by rotating the gripper 15 about the rotational axis 27f of the sixth adjustment drive 26f. It is for this reason that the fifth adjustment drive 26e arranged the closest to the free end 14 was used for the determination of the torque values M1, M2, Ma, the rotational or pivoting axis 27e of said adjustment drive not extending through the gripper 15.

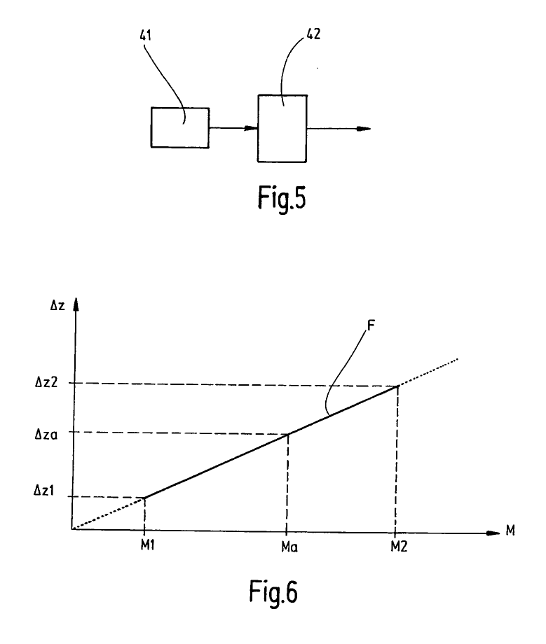

Each of the adjustment drives 26a through 26f comprises a motor 41, preferably an electric motor, and a transmission 42 associated with the motor 41, as is shown in the circuit diagram in accordance with FIG. 5. As a result of the fact that the individual transmissions 42 of the adjustment drives 26 form a total gear ratio or, in the present case, a total reduction ratio, the detectable spread of the torque value M1, M2, Ma with different loading states is not sufficiently great for those adjustment drives 26 that have several additional adjustment drives 26 arranged downstream toward the gripper 15.

Pre-programmed processes for the determination of the deviation function F as well as for the subsequent positioning of the blank 18 in the working position can be stored in the memory of the control unit 25.

The present invention relates to a method for operating a gripping device 10. This method is used for positioning blanks 18 in a working position for the placement of said blanks in a clamping chuck 35. For this, a deviation function F is determined at the time of initialization of the gripping device 10, said deviation function stating only—for the working position—the load-dependent deviation of the position of the blank 18 in vertical direction z between the desired nominal position and the position measured by the gripping device 10. During operation, while the gripping device 10 is positioning the blank 18 in the working position, it is possible to determine a deviation value Δza with the use of the deviation function F and to correct the position measured in the gripping device 10 with the deviation value Δza, so that an accurate positioning of the blank 18 is possible. Therefore, the gripping device 10 sets the blanks 18 with sufficient accuracy within a pre-specified tolerance range, for example five to ten hundredths of millimeters, in a clamping chuck 35, independent of the weight of said blanks. Wear and damage of the clamping chuck 35 are prevented.

### LIST OF REFERENCE SIGNS

10 Gripping Device
11 Gripping arm
12 Member of 11
13 Mounting end 11
14 Free end 11
15 Gripper
16 Gripper tongs
17 Tong legs
18 Blank
19 Mounting surface
25 Control unit
26a First adjustment drive
26b Second adjustment drive
26c Third Adjustment drive
26d Fourth Adjustment drive
26e Fifth Adjustment drive
26f Sixth Adjustment drive
27a Rotational axis 26a
27b Pivoting axis of 26b
27c Pivoting axis of 26c
27d Pivoting axis of 26d
27e Pivoting axis of 26e
27f Rotational axis of 26f
28 Position sensor
35 Clamping chuck
36 Machining region
37 Dividing wall
39 Pallet
40 Abutment element
41 Motor
42 Transmission
A1-A7 Activation signal
F Deviation function
M1 First torque value
M2 Second torque value
Ma Actual torque value
P1-P6 Position signal
z1 First position value
z2 Second position value
Δz1 First deviating value
Δz2 Second deviating value
Δza Actual deviating value

What is claimed is:

1. Method for operating a gripping device (10) that is used for positioning a workpiece or blank (18), the gripping device (10) includes a gripping arm (11) for holding a gripper (15) for clamping the workpiece or blank (18) as desired, the gripper (15) is held on the free end (14) of the gripper arm (11), the gripping arm (11) comprises several members (12), in which case respectively two adjacent members (12) are rotationally or pivotally connected with each other via an adjustment drive (26f, 26e) having an axis (27f, 27e), a control unit (25) is connected in circuit with and receives position signals (P6, P5) and activates via activation signals (A6, A5) the adjustment drive (26f, 26e), said method comprising the following steps:
establishing a fixed pre-specified measuring position of the gripper arm (11),
performing at least two position measurements with different loading states of the gripper (15) and sending position signals (P5) indicative of the at least two position measurements of the gripper (15) to the control unit (25),
determining a deviation function (F), said deviation function (F) describing the change of position of the gripper (15) as a function of the load on said gripper (15) in a pre-determined working position,
pre-programming the control unit (25) with the determined deviation function (F).

2. Method as in claim 1, further characterized by the deviation function (F) is determined by performing the following steps:
determining a first torque value (M1) that describes the first torque (M1) necessary for moving the gripper (15) about the axis (27e) of one of the adjustment drives (26e) in a first loading state,
moving the gripper (15) into the fixed pre-specified measuring position,
measuring a first position value (z1) in the coordinate system of the gripping arm (11),
determining a first deviation value (Δz1) between the measured first position value (z1) and the actual position value;
determining a second torque value (M2) that describes the second torque (M2) necessary for moving the gripper (15) about the axis (27e) of the same adjustment drive (26e) in a second loading state that is different from the first loading state,
moving the gripper (15) into the fixed pre-specified measuring position,
measuring a second position value (z2) in the coordinate system of the gripper (11),
determining a second deviation value (Δz2) between the measured second position value (z2) and the actual position value; and,
establishing, in particular, a linear deviation function (F) between the torque value (M) describing the load on the gripper (15) and the deviation value (Δz).

3. Method as in claim 2, characterized by the gripper (15) is moved, in the fixed pre-specified measuring position, against an abutment (40).

4. Method as in claim 3, characterized by the abutment element (40) is a body that is mounted in a clamping chuck (35).

5. Method as in claim 2, characterized by the two adjacent members (12) of the gripping arm (11) are brought into a pre-specified torque detection location for the determination of the torque values (M1, M2).

6. Method as in claim 5, characterized by the relative position of the two adjacent members (12) of the gripping arm (11) is essentially the same in the measuring position and in the torque detection location.

7. Method as in claim 1, characterized by the deviation function (F) for positioning the blank (18) or workpiece is only applicable to the pre-determined working position of the gripping arm (11), said pre-determined working position being associated with the deviation function (F), within a three-dimensional working region of said gripping arm (11).

8. Method as in claim 2, characterized by the axis (27e) of the adjustment drive (26e) while the torque values (M1, M2) are being determined is essentially aligned in horizontal direction.

9. Method as in claim 2, characterized by only one adjustment drive (26e) of the gripping device (10) is used for determining the torque values (M1, M2).

10. Method as in claim 9, characterized by, between the adjustment drive (26e) used for determining the torque values (M1, M2) and the gripper (15), there is arranged at most the one additional adjustment drive (26f) for the gripper (15).

11. Method as in claim 2, characterized by the gripper (15) is not loaded in the first loading state.

12. Method as in claim 2, characterized by the gripper (15) is loaded in the second loading state with the maximum load occurring during operation of the gripper device (10).

13. Method for picking up and/or depositing a workpiece or blank (18) in a working position with the aid of a gripping device (10) comprising a gripping arm (11) with several members (12), in which case respectively two adjacent members (12) are rotatably and/or pivotally connected with each other via an adjustment drive (26), and in which case a gripper (15) is provided on the outer free end (14) of the gripping arm (11) for holding the blank (18) or workpiece, said method comprising the following steps:
Grasping a blank (18) or workpiece with the gripper;
Determining a torque value (Ma) that describes the torque necessary for moving the gripper (15) with the blank (18) or workpiece about an axis (27e) of one of the adjustment drives (26e);
Detecting a deviation value (Δza) for positioning the blank (18) or workpiece in the working position based on a pre-specified deviation function (F) as a function of the determined torque value (Ma);
Adding the determined deviation value (Δza) to the actual position value measured in the coordinate system of the gripping device (10), said actual position value being measured while positioning the blank (18) or workpiece that is held in the gripper (15) in the working position.

14. A gripping device (10) for positioning a workpiece or blank (18), the gripping device (10) comprises:
a gripping arm (11) for holding a gripper (15) for clamping the workpiece or blank (18) as desired, the gripper (15) is held on the free end (14) of the gripper arm (11),
the gripping arm (11) comprises several members (12), in which case respectively two adjacent members (12) are rotationally or pivotally connected with each other via an adjustment drive (26f, 26e) having an axis (27f, 27e),
a control unit (25) is connected in circuit with and receives position signals (P6, P5) and activates via activation signals (A6, A5) the adjustment drive (26f, 26e),
means for determining a deviation function (F),
wherein said deviation function (F) describes the change of position of the gripper (15) as a function of the load on said gripper (15) in a pre-determined working position.

15. The gripping device of claim 14, wherein said control unit (25) comprises a program with said means for determining a deviation function including performing the following steps:
determining a first torque value (M1) that describes the first torque (M1) necessary for moving the gripper (15) about the axis (27e) of one of the adjustment drives (26e) in a first loading state,
moving the gripper (15) into the fixed pre-specified measuring position,
measuring a first position value (z1) in the coordinate system of the gripping arm (11),
determining a first deviation value (Δz1) between the measured first position value (z1) and the actual position value;
determining a second torque value (M2) that describes the second torque (M2) necessary for moving the gripper (15) about the axis (27e) of the same adjustment drive (26e) in a second loading state that is different from the first loading state,
moving the gripper (15) into the fixed pre-specified measuring position,
measuring a second position value (z2) in the coordinate system of the gripper (11),
determining a second deviation value (Δz2) between the measured second position value (z2) and the actual position value; and,
establishing, in particular, a linear deviation function (F) between the torque value (M) describing the load on the gripper (15) and the deviation value (Δz).
